(19) United States
(12) Patent Application Publication
(10) Pub. No.: US 2007/0137403 A1
(43) Pub. Date: Jun. 21, 2007

(54) Rod clip

(76) Inventor: Joseph Anscher, Muttontown, NY (US)

Correspondence Address: WILLIAM COLLARD;COLLARD & ROE, P.C., 1077 NORTHERN BOULEVARD, ROSLYN, NY, 11576, US

(21) Appl. No.: 11/238,862

(22) Filed: Sep. 29, 2005

(51) Int. Cl. G05G 1/04

(52) U.S. Cl. 74/519

(57) ABSTRACT

A clip secures a rod having a right-angle bend to a structure. The clip has a base with an aperture for receiving an end of the rod, and an arm extending from a top surface of the base. The arm has a mechanism for securing the rod on an opposite side of the right-angle bend from the end of the rod. The clip has a locking structure for securing the base to a structure. The clip is inserted through an elongated aperture in the structure and is secured to the structure in a preliminary locking position. The end of the rod is then inserted into the aperture in the base while the clip is in the preliminary locking position, and secured to the arm by rotating the rod until it snaps into the rod-securing mechanism. The clip is then moved into the fully locked position to secure the clip and rod to the structure.

### BACKGROUND OF THE INVENTION

1. Field of the Invention

This invention relates to a clip for securing rods within an aperture of a structure, such as a lever of a door locking structure assembly. In particular, the invention relates to a clip for use with a rod that is bent at a right angle at its end. The clip secures both the end of the rod and a location distal from the bend, to prevent sliding of the rod after it has been secured. In one embodiment, the clip can be structured so that it can be assembled into the lever prior to insertion of the rod, so that the lever and clip can be shipped pre-assembled.

2. The Prior Art

Right-angled rods are often used in actuating devices, such as vehicle door locking structures, to translate motion from a handle to the locking structure at a remote location, via a lever. To secure the rod to the locking structure lever, many different mechanisms have been used. The lever commonly has an elongated aperture through which the rod is inserted. The elongated aperture has a greater tolerance for manufacturing deviations in the position of the rod and allows the rod to be more easily positioned in the locking structure. Such a structure is commonly referred to as a “lost motion” device, since the rod can move within the aperture without engaging the locking structure.

In order to use such a lever, there must be some device to keep the rod in place within the elongated aperture of the lever. This is often another clip that snaps into the aperture of the lever. Examples of such a rod clip are shown in U.S. Pat. No. 6,322,274 to Binotti et al., U.S. Pat. No. 6,116,807 to Dzurko et al., U.S. Pat. No. 6,533,487 to Clark, and U.S. Pat. No. 4,306,820 to Nelson. While these clips fit within the elongated aperture of the lever, they are often not durable enough to withstand the loads placed on them by the rod, especially when the parts are used in automotive applications, such as automobile door locking systems. In addition, these clips must be placed into the lever at the time the rod is inserted, thus adding additional time and labor to the door assembly process.

### SUMMARY OF THE INVENTION

It is therefore an object of the invention to provide a rod clip that can be easily installed into an aperture and yet withstand significant force without breaking.

It is another object of the invention to provide a rod clip that can be installed into and remain fixed in an elongated aperture prior to insertion of the rod into the clip, to allow both the clip and lever to be shipped pre-assembled.

It is another object of the invention to provide a clip that is simple and inexpensive to manufacture.

These and other objects are accomplished by a clip for securing a rod having a right-angle bend at one end thereof to a structure, comprising a base having an aperture therethrough for receiving an end of the rod and an arm extending from a top surface of the base. The arm has a mechanism for securing the rod on an opposite side of the right-angle bend, to keep the rod in the clip. The clip has a locking structure connected to a lower portion of the base for securing the base to a structure having an elongated opening. The clip is first inserted through the elongated opening in the structure. The end of the rod is then inserted into the aperture in the base, and secured to the arm by rotating the rod until it snaps into the rod-securing mechanism. The rod-securing mechanism is preferably a C- or U-shaped clip that snaps around the rod. At the same time, the rod and clip are securely locked to the lever by rotating the rod-clip arrangement by 90 degrees to move the clip into a fully locked position, which strongly secures the clip and the rod to the lever.

In a preferred embodiment, the locking structure of the clip is inserted into the elongated aperture in the lever and is held in a preliminary locking position within the aperture prior to insertion of the rod or rotation of the clip. The clip can be inserted in any location along the elongated opening, but still be held securely within the aperture without falling out during shipping.

The locking structure preferably comprises an elongated section extending perpendicular to the aperture in the clip. The elongated section is inserted parallel to the longitudinal direction of the elongated opening, until the locking structure passes through the aperture. At this point, the locking structure may preliminary engage the lever because the sides of the elongated section can be sized so that they snap into an underside of the lever after the locking structure passes through the elongated aperture in the lever. Alternatively, the clip can rest loosely within the aperture and not engage the lever at this point, so that it can be removed easily from the lever prior to insertion of the rod. After the rod is attached to the clip, the clip is then rotated 90 degrees so that the elongated section is perpendicular to the longitudinal direction of the elongated aperture, and thus has a significant surface area that abuts an underside of the structure to strongly secure the clip to the structure.

To allow the locking structure to pass through the elongated opening of the structure, one embodiment of the locking structure has a channel bisecting the elongated section in a longitudinal direction. This allows the locking structure to be compressed during insertion of the locking structure through the opening, and thus allows the locking structure to be made slightly wider than the narrowest part of the elongated opening, to provide the preliminary locking position.

The locking structure can also have a series of protrusions that extend beyond the width of the elongated opening. The protrusions pass through the opening and snap into an underside of the structure after the clip has been fully inserted. This keeps the locking structure attached to the structure in the preliminary locking position even before the locking structure is rotated into a fully locked position with the elongated section perpendicular to the opening. This preliminary locking position allows the clip and the lever to be connected prior to assembly of the locking structure, so that the clip and lever can be shipped pre-assembled to the automobile manufacturer. This saves considerable labor time during assembly of the automobile doors.

In an alternative embodiment, instead of a channel bisecting the locking structure, the locking structure can have a flexible tongue disposed along the long side of the elongated section. The tongue compresses as the locking structure is inserted through the opening and is then released to keep the clip secured to the structure in the preliminary locking position.

The arm that secures the rod, and the locking structure on the base, preferably extend perpendicular to each other. This allows for optimal positioning of the rod after the clip is locked to the lever.

The arm preferably has a reinforced wall along at least one side, to prevent breakage of the arm prior to being locked to the rod.

The clip preferably further has a set of wings located along a top surface of the base. The wings extend out parallel to the elongated sections of the locking structure and further secure the clip to the lever in the fully locked position. In this fully locked position, the wings extend beyond the elongated opening and abut the top surface of the structure and prevent further downward movement of the clip into the elongated opening. The wings also assist in preventing any rotation of the clip after it is fully locked, due to the frictional forces created by the wings pressing onto the top surface of the structure. The top surface of the clip preferably has a larger diameter than the narrow width of the elongated opening so that the clip cannot inadvertently fall through the opening as it is being inserted.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a perspective view of one embodiment of the clip according to the invention prior to insertion into a lever;

FIG. 2 shows the clip according to claim 1 inserted into a lever;

FIG. 3 shows a view from the underside of the arrangement of FIG. 2;

FIG. 4 shows the clip of FIGS. 1 and 2 inserted into a lever with a rod inserted therethrough;

FIG. 5 shows the rod of FIG. 4 snapped into the clip and the clip rotated to lock into the lever;

FIG. 6 shows a view from the underside of the arrangement of FIG. 5;

FIG. 7 shows the arrangement of FIG. 5 with the lever in a closed position;

FIG. 8 shows another embodiment of the clip according to the invention prior to insertion into a lever;

FIG. 9 shows the embodiment of FIG. 8 inserted into the lever;

FIG. 10 shows a view from the underside of the arrangement of FIG. 9;

FIG. 11 shows the arrangement of FIG. 9 with a rod inserted therein; and

FIG. 12 shows the arrangement of FIG. 11 with the rod locked into the clip according to the invention, the clip according to the invention locked into the lever and the lever in a closed position; and

FIG. 13 shows an underside view of a third embodiment of the invention inserted into a lever.

### DETAILED DESCRIPTION OF THE PREFERRED EMBODIMENT

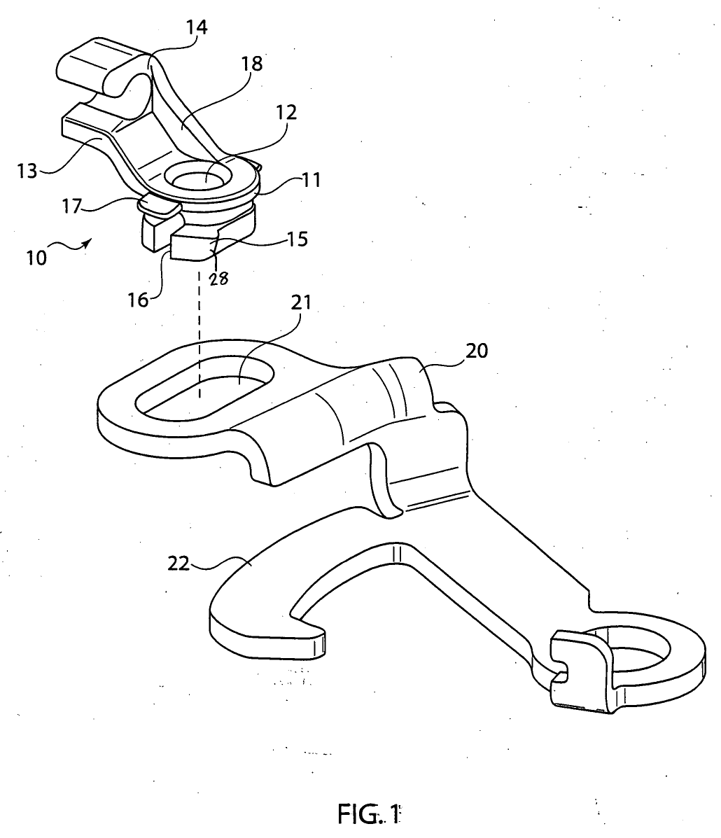

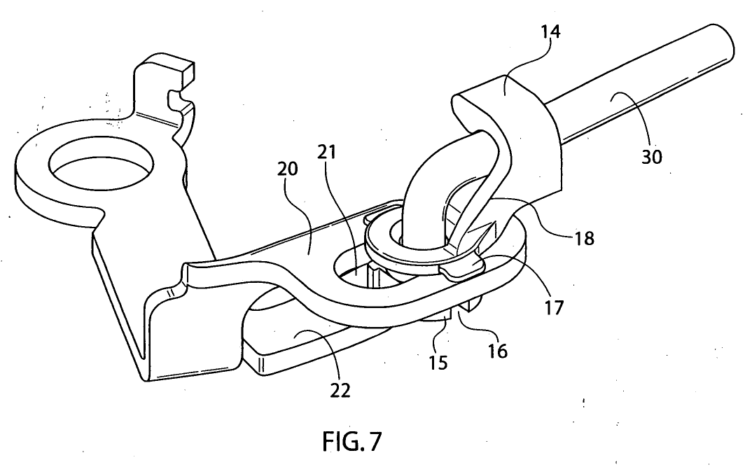

Referring now in detail to the drawings, FIGS. 1-7 show a first embodiment of the clip 10 according to the invention as it is inserted into an opening 21 of a lever 20, and secured to a rod 30. Clip 10 comprises a base 11 having an aperture 12 for receiving an end 31 of rod 30. Extending from a top surface of base 11 is an arm 13 having a C-shaped clip 14 for securing a section of rod 30 that is bent away from end 31 at a 90 degree angle. Arm 13 is supported by a wall 18, which is connected to base 11 and prevents breakage of arm 13. Clip 10 has a locking structure comprised of an elongated section 15, which extends outward in two directions beyond the circumference of aperture 12. Elongated section 15 is bisected by a channel 16, which allows elongated section 15 to be compressed under lateral pressure.

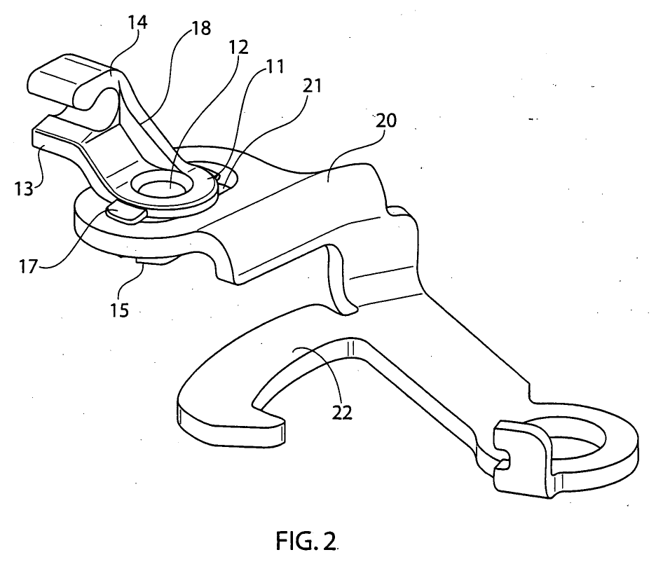

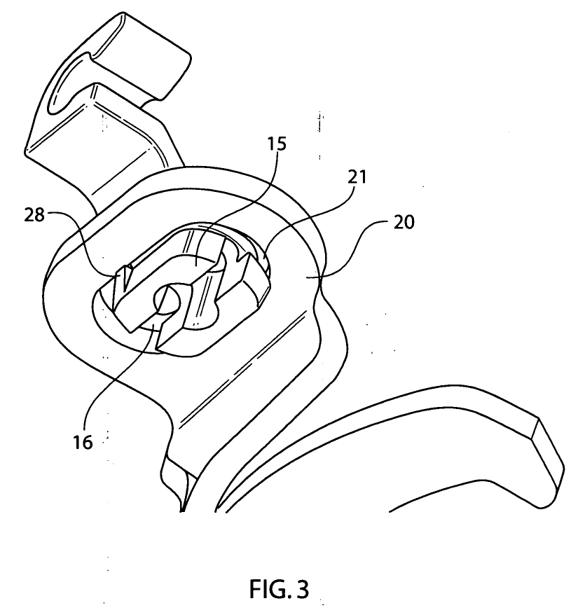

In use, clip 10 is inserted into elongated opening 21 of lever 20, along the dotted lines shown in FIG. 1, until it reaches a preliminary locking position shown in FIG. 2. During insertion, elongated section 15 extends parallel with elongated opening 21 of lever 20 as it passes through opening 21. Elongated section 15 is slightly wider than the width of elongated opening 21, via protrusions 28, and is compressed into channel 16 as it passes through opening 21. After clip 10 is fully inserted into opening 21, elongated section 15 snaps back into a resting position, where protrusions 28 abut an underside of lever 20 and keeps clip 10 secured in lever 20, in the preliminary locking position, as shown in FIG. 3.

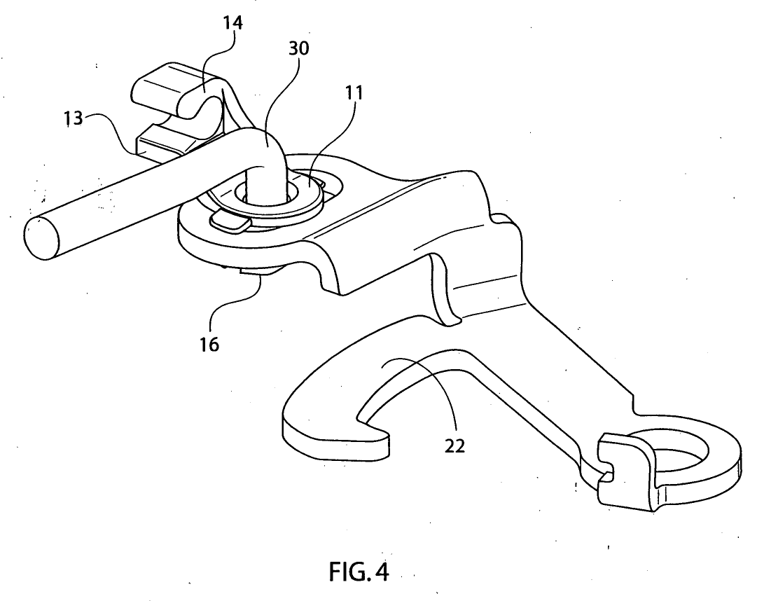

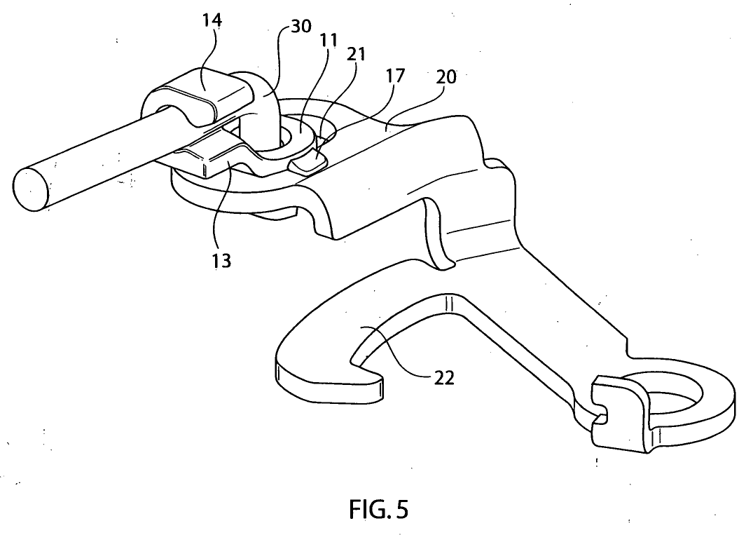

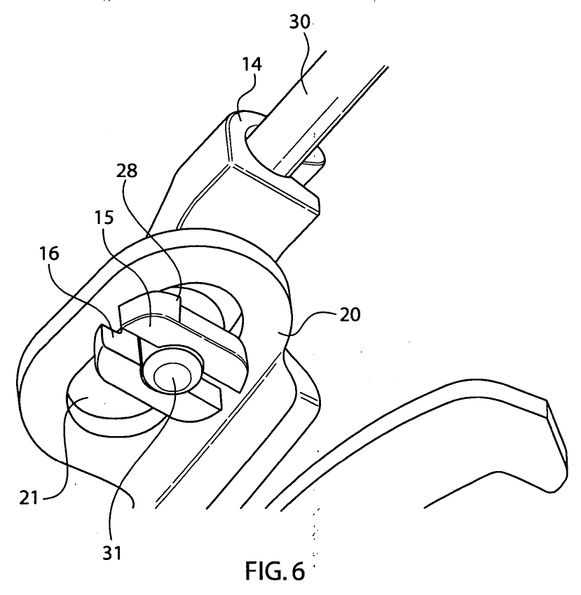

After clip 10 is placed in the preliminary locking position described above, a rod 30, having a right-angle bend, is inserted into aperture 12, as shown in FIG. 4. Rod 30 is then snapped into C-shaped clip 14 to prevent rod 30 from rotating within clip 10. At the same time, or at a different time, clip 10 is then rotated 90 degrees until elongated section 15 is disposed across elongated opening 21, so that elongated section 15 extends beyond opening 21 to abut an underside of lever 20 and securely lock clip 10 to lever 20, as shown in FIGS. 5 and 6. Clip 10 also has two wings 17 extending from the top side of base 11. Wings 17 abut a top surface of lever 20 in the fully locked position, and prevent any downward movement of clip 10 into opening 21. Wings 17 also add to the frictional forces maintaining clip 10 in the fully locked position, so that clip 10 does not rotate back into the first locking position inadvertently.

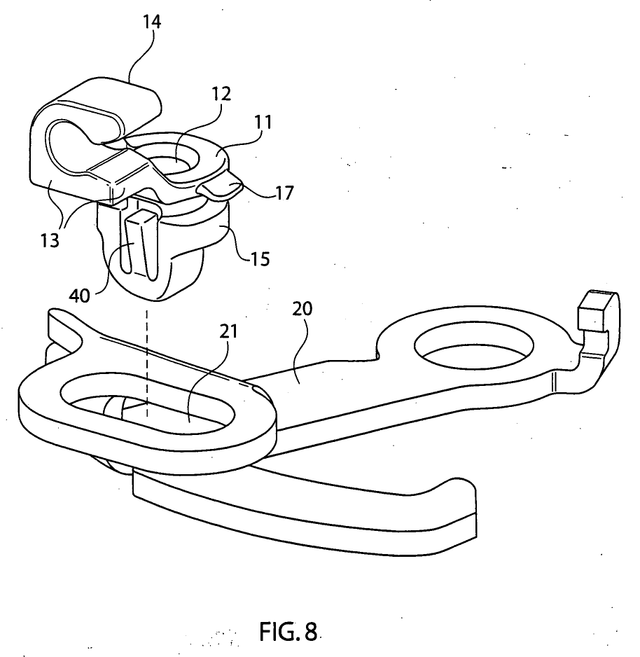

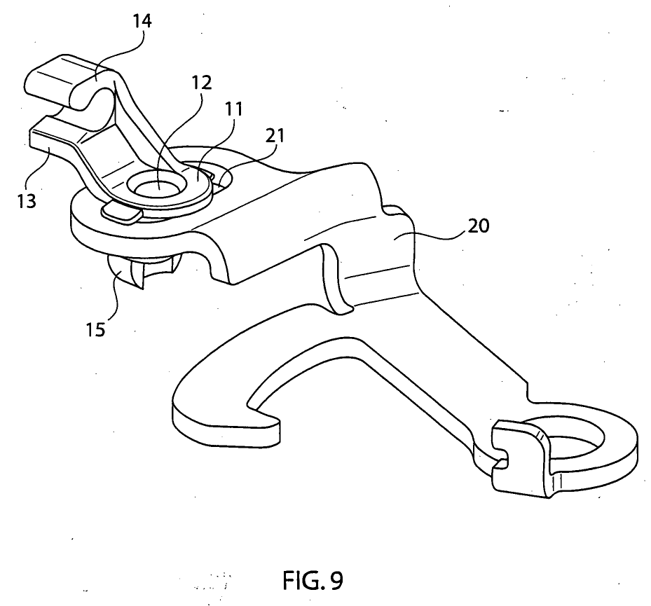

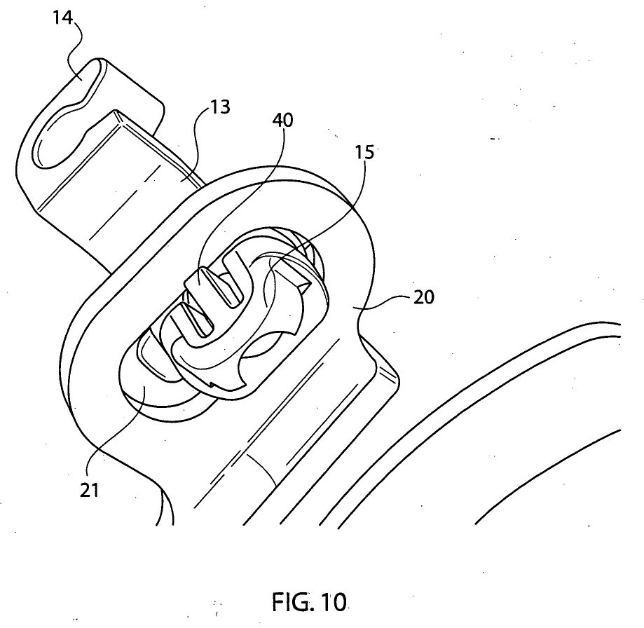

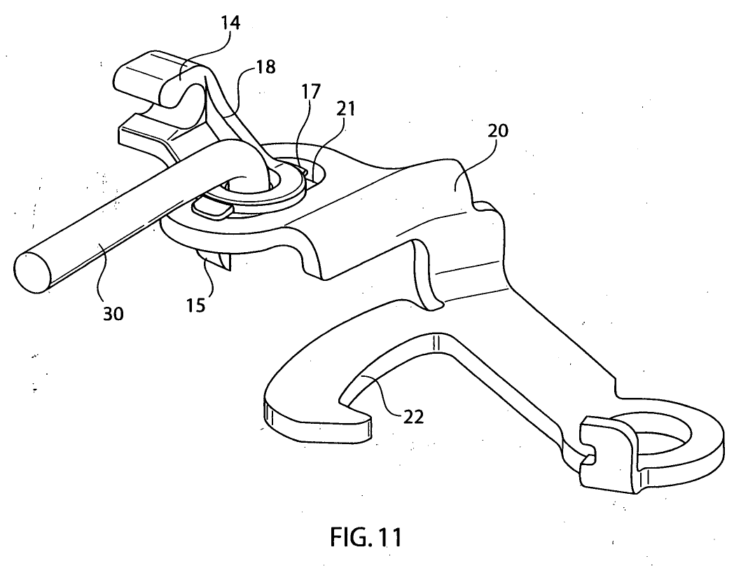

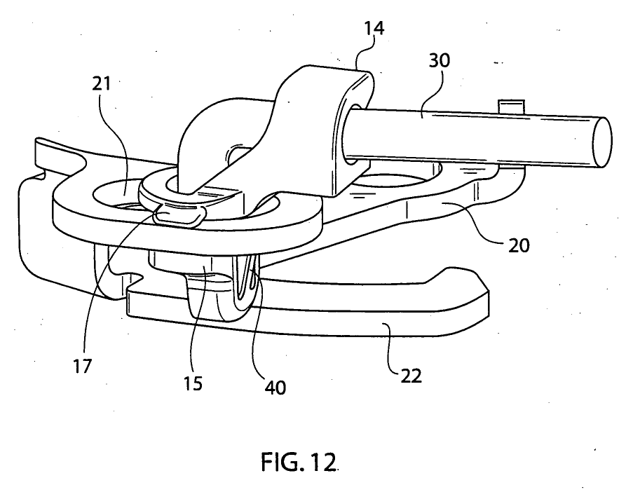

In another embodiment, shown in FIGS. 8-10, clip 10 operates the same way as the embodiment in FIGS. 1-7, except that instead of channel 16, there is at least one flexible tongue attached to a side of elongated section 15. In this embodiment, elongated section 15 is narrower than the width of opening 21, but flexible tongue 40 extends beyond the width of opening 21, so that flexible tongue 40 compresses as it passes through opening 21 shown in FIG. 8, and snaps into a preliminary locking position as shown in FIGS. 9 and 10. As shown in FIG. 10, the end of flexible tongue 40 abuts an underside of lever 20 to secure clip 10 into the first locking position. The insertion of rod 30 and the rotation of clip 10 into the fully locked position proceeds the same as with the first embodiment. FIG. 11 shows insertion of rod 30 into aperture 12, and FIG. 12 shows the securing of rod 30 into C-shaped clip 14 and the rotation of clip 10 into the fully locked position so that elongated section 15 abuts the underside of lever 20.

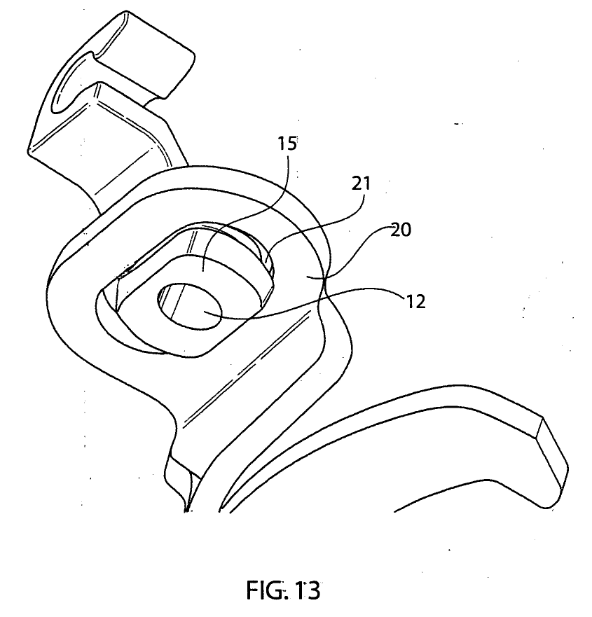

FIG. 13 shows an underside view of yet another embodiment according to the invention. Here, clip 10 does not have a preliminary locking position, and merely rests loosely in elongated opening 21 until it is rotated into its fully locked position.

Accordingly, while only a few embodiments of the present invention have been shown and described, it is obvious that many changes and modifications may be made thereunto without departing from the spirit and scope of the invention.

What is claimed is:

1. A clip for securing a rod having a right-angle bend at one end thereof to a structure, comprising:
a base having an aperture therethrough for receiving an end of the rod;
an arm extending from a top surface of the base, said arm having a mechanism adapted to securing the rod on an opposite side of said right-angle bend from said end of said rod; and
a locking structure connected to a lower portion of said base for securing the base to a structure, such when said clip is inserted through an elongated aperture in the structure and rotated 90 degrees within the aperture in the structure, the locking structure secures the clip to the structure in a fully locked position.

2. The clip according to claim 1, wherein the locking structure has a preliminary locking position, such that when said clip is inserted into an elongated opening, the clip is held in place in the preliminary locking position prior to being rotated 90 degrees.

3. The clip according to claim 1, wherein the mechanism for securing the rod comprises a substantially C-shaped clip that is adapted to be snapped around the rod to prevent rotation of the rod within the clip.

4. The clip according to claim 1, wherein the locking structure comprises an elongated section extending perpendicular to said aperture, said elongated section abutting an underside of said structure when said clip is inserted into said elongated aperture in the structure and rotated 90 degrees into the fully locked position.

5. The clip according to claim 4, wherein the locking structure has a channel bisecting the elongated section in a longitudinal direction, allowing the locking structure to be compressed during insertion of the locking structure through an opening, to place the clip a preliminary locking position where the clip is locked to the structure prior to rotation into the fully locked position.

6. The clip according to claim 4, wherein the locking structure has a flexible tongue that is compressed when the clip is inserted into an opening in the structure, and released after the clip is fully inserted, to place the clip into a preliminary locking position where the clip is locked to the structure prior to rotation into the fully locked position.

7. The clip according to claim 1, wherein the arm and the locking structure extend perpendicular to each other.

8. The clip according to claim 4, further comprising at least one wing extending out of a top surface of the base, parallel to said elongated section, wherein when said elongated section abuts an underside of the structure, said wing abuts a top surface of said structure adjacent the elongated aperture to further secure the clip to the structure.

9. A combination clip and lever for securing a rod having a right-angle bend to the lever, comprising:
(1) a clip comprising:
(a) a base having an aperture therethrough for receiving an end of the rod;
(b) an arm extending from a top surface of the base, said arm having a mechanism for securing the rod on an opposite side of said right-angle bend from said end of said rod; and
(c) a locking structure connected to a lower portion of said base; and
(2) a lever having an elongated opening therethrough, such that when clip is inserted through said opening and rotated 90 degrees within the opening, the clip is secured to the lever in a fully locked position.

10. The combination according to claim 9, wherein the locking structure comprises an elongated section extending perpendicular to said aperture, said elongated section passing through said opening when the clip is inserted into the opening and abutting an underside of said lever when said clip is rotated 90 degrees into the fully locked position.

12. The combination according to claim 9, wherein said locking structure secures the clip in a preliminary locking position to the lever when said clip is inserted through the elongated opening, and prior to rotation of the clip in a fully locked position.

13. The combination according to claim 10, wherein the locking structure has a channel bisecting the elongated section in a longitudinal direction, allowing the locking structure to be compressed during insertion of the locking structure through the opening, so that a portion of the elongated section overlaps elongated edges of the elongated opening to hold the clip in a preliminary locking position where the clip is locked to the lever prior to rotation of the clip into a fully locked position.

14. The combination according to claim 13, wherein the portion of the elongated section that overlaps the elongated edges comprises at least one protrusion extending out from the elongated section.

15. The combination according to claim 10, wherein the locking structure has a flexible tongue that is compressed when the clip is inserted into the opening and released after the clip is fully inserted, so that ends of the tongue abut an underside of the lever, to place the clip into a preliminary locking position where the clip is locked to the lever prior to rotation of the clip into a fully locked position.

14. The combination according to claim 10, wherein the arm and the locking structure extend perpendicular to each other.

15. The combination according to claim 10, further comprising at least one wing extending out of a top surface of the base, parallel to said elongated section, wherein when said elongated section abuts an underside of the lever, said wing abuts a top surface of said lever adjacent the opening to further secure the clip to the lever in a fully locked position.

16. The combination according to claim 9, wherein the mechanism for securing the rod comprises a substantially C-shaped clip that is adapted to be snapped around the rod to prevent rotation of the rod within the clip.
